(19) United States
(12) Patent Application Publication
(10) Pub. No.: US 2025/0258648 A1
(43) Pub. Date: Aug. 14, 2025

(54) APPARATUS AND METHOD WITH IN-REGISTER COMPUTING

(71) Applicant: SAMSUNG ELECTRONICS CO., LTD., Suwon-si (KR)

(72) Inventors: Wooseok Yi, Suwon-si (KR); Soon-Wan KWON, Suwon-si (KR)

(73) Assignee: SAMSUNG ELECTRONICS CO., LTD., Suwon-si (KR)

(21) Appl. No.: 19/000,300

(22) Filed: Dec. 23, 2024

(30) Foreign Application Priority Data
Feb. 8, 2024 (KR) 10-2024-0019944

(51) Int. Cl. G06F 7/50; G06F 12/06

(52) U.S. Cl. CPC G06F 7/50; G06F 12/06

(57) ABSTRACT

An in-register computing (IRC) device includes: a register module including a register bank and an addition device, the register bank including register cells, the register cells including IRC cells, wherein the register module is configured to allocate first of the register cells to an input area, second of the register cells to a weight area, and third of the register cells to an output area, wherein the input area is an area in which the register bank stores an input value, the weight area is an area including one of the IRC cells configured to perform an IRC operation between the input value and a weight value, and the output area is an area configured to store an output value obtained by performing an addition operation on an operation result of the IRC operation using an addition device.

### CROSS-REFERENCE TO RELATED APPLICATIONS

This application claims the benefit under 35 USC § 119 (a) of Korean Patent Application No. 10-2024-0019944, filed on Feb. 8, 2024, in the Korean Intellectual Property Office, the entire disclosure of which is incorporated herein by reference for all purposes.

### BACKGROUND

### 1. Field

The following description relates to an apparatus and method with in-register computing.

### 2. Description of Related Art

Registers are key components of central processing units (CPUs). A register may be located inside a CPU and used to store and process data. Typically, a CPU fetches data from a memory into the register, performs calculations, stores a result back in the register, and returns the result from the register to the memory.

Register are usually high-speed storage and may have a characteristic that allows very fast CPU access. A register may be used to execute instructions of the CPU and to temporarily store data. In general, registers have a small capacity (e.g., up to 256 bits), and there may be various types and numbers of registers depending on the type of CPU.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an in-register computing (IRC) device includes: a register module including a register bank and an addition device, the register bank including register cells, the register cells including IRC cells, wherein the register module is configured to allocate first of the register cells to an input area, second of the register cells to a weight area, and third of the register cells to an output area, wherein the input area is an area in which the register bank stores an input value, the weight area is an area including one of the IRC cells configured to perform an IRC operation between the input value and a weight value, and the output area is an area configured to store an output value obtained by performing an addition operation on an operation result of the IRC operation using an addition device.

The register module may further include: a register cell allocated to the input area configured to perform a function of the input area; or a register cell allocated to the output area configured to perform a function of the output area.

The register module may be further configured to: compare a number of columns of a matrix of the weight value to a number of lanes, wherein a lane includes the register bank; and based on the comparing, control a number of the register cells to be allocated to the input area and a number of the register cells to be allocated to the output area.

The register module may be further configured to: control an operation order of the one of the IRC cells and control a method of storing the operation result based on a result of the comparing.

The register module may be further configured to: control a method of storing a vector element in the input area and the output area based on an operation method of the IRC device.

The register module may be further configured to: control a number of vector elements to be stored in one of the register cells, based on an operation method of the IRC device.

The IRC device may be configured to: allocate the input area, the weight area, and the output area using different types of register files.

The register module may include a scalar register, a vector register, or a floating register.

The IRC device may be configured to track which of the register cells are allocated to which of the areas and control the register bank accordingly.

The IRC cells may include respective operators configured to perform operations between data stored in the IRC cells and other of the register cells.

The addition device may include a digital adder module, an analog adder module, a separate adder module, or a variable adder module.

The IRC device may further including a memory configured to store instructions related to the IRC device.

In another general aspect, an in-register computing (IRC) method includes: receiving, by a register module, data, the register module including register cells, the register cells including IRC cells, each IRC cell configured to perform an operation on data stored therein; designating a first portion of the register cells as an input area in which an input value is stored; designating a second portion of the register cells, including one or more of the IRC cells, as a weight area, wherein the one or more IRC cells of the weight area configured to perform their respective operations between the input value and a weight value in the one or more IRC cells; and designating a third portion of the register cells as an output area configured to store a result of the operations on the input value.

The register cells may be included in one or more register banks, and wherein the register module manages the registers cells according to their designated areas such that register cells in one of the designated areas are configured to perform one function based on their being in the one of the designated areas and such that register cells in another of the areas are configured to perform another function based on their being in another of the designated areas.

The register cells may be included in register banks, data lanes may include the register banks, respectively, and the register module may be configured to: compare a number of columns of a matrix of the weight value to the number of lanes; and based on the comparing, control how many of the register cells are designated to the input area and how many of the register cells are designated to the output area.

The register module may be further configured to: control an operation order of the one or more IRC cells and control a method of storing the result of the operations based on a result of the comparing.

The register module may be configured to: control a method of storing a vector element in the input area and the output area based an operation method of the IRC method.

The register module may be configured to: control a number of vector elements to be stored in one of the register cells, based an operation method of the IRC method.

The IRC method may further include: designating the input area, the weight area, and the output area using different types of register files.

The register module may include: at least one of a scalar register, a vector register, or a floating register.

Other features and aspects will be apparent from the following detailed description, the drawings, and the claims.

### BRIEF DESCRIPTION OF THE DRAWINGS

FIGS. 1A and 1B illustrate an example structure of a register cell that performs an in-register computing operation, according to one or more embodiments.

FIG. 2 illustrates an example of a register module, according to one or more embodiments.

FIG. 3 illustrates example structure of a register module, according to one or more embodiments.

FIG. 4 illustrates an example of an area allocation method, according to one or more embodiments.

FIGS. 5 to 7 illustrate an example of allocating an area to a scalar register and performing in-register computing, according to one or more embodiments.

FIG. 8 illustrates an example of allocating an area to a vector register and performing in-register computing, according to one or more embodiments.

FIGS. 9 and 10 illustrate an example of storing a vector element, according to one or more embodiments.

FIGS. 11 to 13 illustrate an example of performing in-register computing using different types of register modules, according to one or more embodiments.

FIGS. 14 and 15 illustrate an example of in-register computing, according to one or more embodiments.

FIGS. 16 to 19 illustrate examples of performing in-register computing in a vector register, according to one or more embodiments.

FIG. 20 illustrates an example of performing in-register computing on a scalar register file, according to one or more embodiments.

FIG. 21 illustrates an example of a vector register, according to one or more embodiments.

FIG. 22 illustrates an example of an operation of a vector execution pipeline, according to one or more embodiments.

FIG. 23 illustrates an example of a vector operation instruction, according to one or more embodiments.

FIGS. 24 and 25 illustrate an example of an instruction in a vector-matrix multiplication operation, according to one or more embodiments.

FIG. 26 illustrates an example of a vector operation to which a tensor execution pipeline is added, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Various types of registers may be present in a CPU, depending on its type or design. For example, a data register may be used to store and process data. The data register may also be used to store data needed to perform an arithmetic operation or a logical operation and to store a result of the operation. An address register may be used to store a memory address. The address register may store address information used when the CPU reads data from a memory or writes data to a memory. An instruction register may be used to store an instruction currently being executed. The instruction register may help the CPU determine which instruction to execute next. A vector register may be provided in a CPU that supports a vector operation. The vector operation may simultaneously perform an operation on multiple data elements (in a vector) of a same type. The vector register may be used to store and process a data element to efficiently perform the vector operation.

Register play an important role in the performance and efficiency of CPUs. By storing and processing data in a register, a CPU may avoid being limited by the operating speed of accessing memory and may therefore perform a task faster than if using the memory. In short, use of registers may improve program execution speed.

A register file is a storage unit that includes multiple registers. A register is a set of registers in a CPU that may quickly provide data needed for the CPU to perform an operation. For example, a register file may include multiple registers that allow a processor to process multiple data items simultaneously.

A register bank is similar to a register file but may be a grouping of multiple registers. A register bank may be included in data parallel processing or a pipeline structure and may be used to increase efficiency of data processing. A register bank may be a set of registers optimized for a specific type of operation or a specific mode of operation.

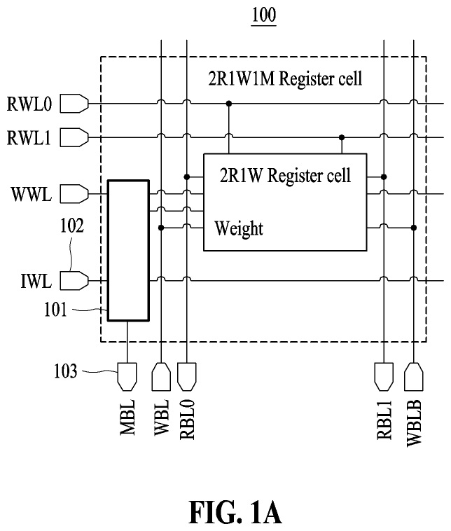

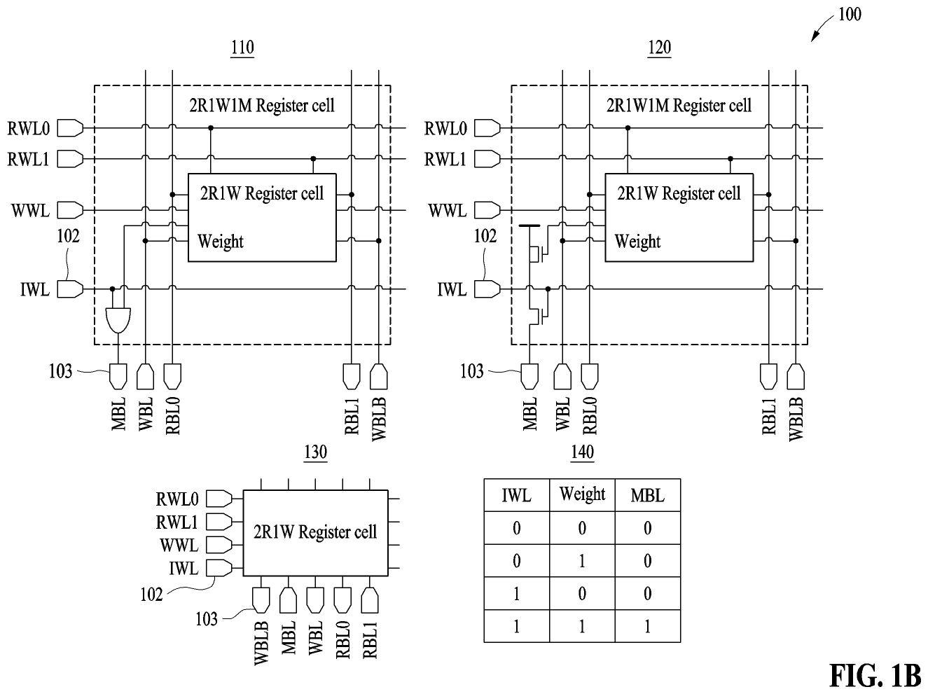

FIGS. 1A and 1B illustrate example structure of a register cell that performs an in-register computing operation, according to one or more embodiments.

In-register computing (IRC) designs may be applied to scalar registers, vector registers, data registers, floating-point registers, and the like. However, for ease of description, application of IRC to a scalar register and to a vector register are mainly described herein.

A register file configured to perform an IRC operation may include register cells that carry out the IRC operation.

An IRC cell (e.g., an IRC cell 100) may be a two read-one write (2R1W) register cell to which an operator 101 for an operation is added. The operator 101 may be configured to perform its operation between an input value and a stored value (the input value and the stored value may be operands of the operation). As a non-limiting example, the stored value may be a weight value of a neural network, and the input value may be a value of data being inferenced by the neural network. The operation may be an in-register operation in that the stored value is continuously stored in the register before, during, and after the in-register operation is performed. That is to say, the stored value is not necessarily loaded into the IRC cell specifically for the in-register operation.

In the circuit structure of a general register cell, a portion to store data has a flip-flop form without a significant difference from static random-access memory (SRAM). However, a general register cell may have two read ports and one write port and may correspondingly include three word lines (WLs), for example, two for read and one for write, and three bit lines (BLs), for example, two for read and one for write. A vector register cell may include four read ports and two write ports. However, a basic framework of these two types of register cell is an SRAM structure, but with a difference in the numbers of WLs and BLs. Thus, an SRAM-based in-memory computing method may be applied to the register cell.

Referring to FIG. 1A, a value may be applied to a read word line 0 RWL0 for performing a read operation to read the value through a read bit line 0 RBL0, or a value may be applied to a read word line 1 RWL1 to read the value through a read bit line 1 RBL1. After applying a value to a write bit line WBL and a write bit line bar WBLB, a desired value may be written to the register cell by applying the desired value to a write word line WWL. Here, the IRC cell 100 may be augmented with the operator 101, which is configured to perform a multiplication operation between an input value and a stored value (e.g., a weight). Similarly, the IRC cell 100 may be augmented with an input word line (IWL) 102 (to which the input value is inputted) and a multiply bit line (MBL) 103 (to output a multiplication result) to implement the operation capability of the IRC cell 100. As augmented, the IRC cell 100 may include two read-one write-one multiply (2R1W1M) bit line. The operator 101 may perform an operation between the IWL 102 and the stored value. The operator 101 may output an operation result through the MBL 103. However, the IRC cell 100 described herein is not limited to 2R1W1M. For example, the IRC cell 100 may be implemented as four read-two write-one multiply (4R2W1M). The IRC cell 100 may be implemented in various types of register cells mentioned above.

Referring to FIG. 1B as an example of the operator 101, in the IRC cell 100, a first IRC cell 110 is an example of the IRC cell 100 included in an IRC device in which the operator 101 is implemented as an AND gate. In another example, in the 2R1W1M IRC cell 100, a second IRC cell 120 is an example of the IRC cell 100 included in an IRC device in which the operator 101 is implemented as an NMOS. In addition, an IRC cell module 130, which is a simplified version of the IRC cell 100, and a truth table 140 of the IRC cell 100 are shown in FIG. 1B. The IRC cell 100 may be implemented in various register files and register cells and may additionally include the operator 101 to perform an IRC operation.

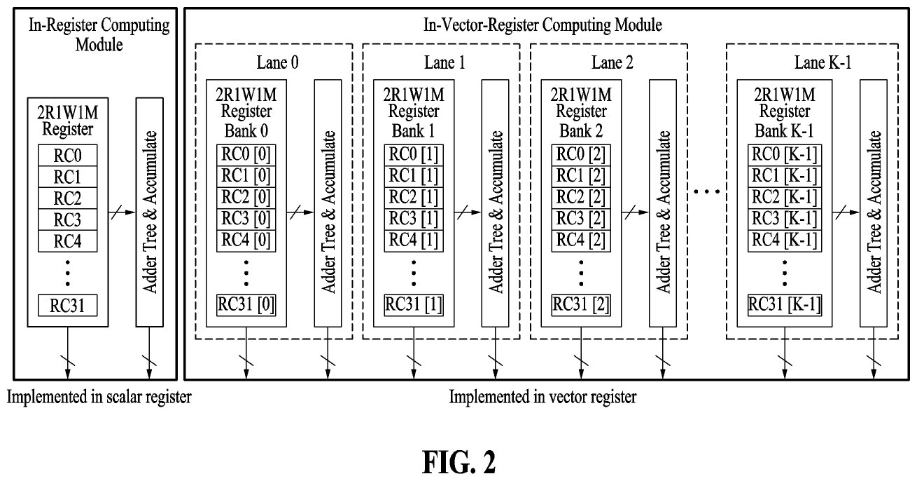

FIG. 2 illustrates an example of a register module, according to one or more embodiments.

The description provided with reference to FIGS. 1A and 1B is generally applicable to FIG. 2.

An IRC device may include a register module 200 including at least one register bank (or file) and an addition device (e.g., an adder tree & accumulate as shown in FIG. 2) associated with the register bank. In addition, the IRC device may further include a memory (not shown) that stores instructions related to IRC. The register module 200 may receive the instructions and perform IRC accordingly.

The register module 200 may allocate (i) a role related to an input area, (ii) a role related to a weight area, and/or (iii) a role related to an output area, and such role(s) may be allocated to each of the register cells included in each of the at least one register bank. That is to say, register cells may be assigned or designated to different areas (possibly with qualifications, as described herein). The assignments/designations may be tracked (information about the stored) and used to control the IRC device in various ways described herein. The input area may be an area of the register bank that stores an input value. The weight area may be an area including an IRC cell that is configured to perform an operation between the input value in the input area and a weight value stored in the IRC cell (in the weight area), which may generate an operation result. The output area may be an area configured to store an output value obtained by adding the operation result of the weight area using the addition device.

The addition device may be implemented as, for example, a digital adder module, an analog adder module, a separate adder module, or a variable adder module. The register module 200 may add together values calculated by the operators 101 of the IRC cells 100 using the addition device. That is, the addition device may receive, as an input, multiple operation result values calculated by operators 101 of the respective IRC cells 100 and perform an addition operation (e.g., a summate operation) on the operation result values.

The input area (e.g., I area 310), the weight area (e.g., W area 330), and the output area (e.g., O area 350) are described below.

Referring to FIG. 2, the register module 200 may be implemented using instances of the IRC cell 100. RC0 to RC31 may be registers that include respective groups of IRC cells 100 (each RCX may include, for example, a word of IRC cells 100). IRC refers to performing an operation in the register module 200, in particular by the IRC cells 100, which can perform an operation in a manner similar to how in-memory computing may be performed.

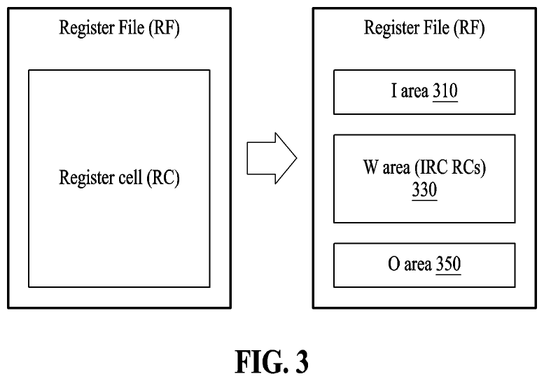

FIG. 3 illustrates example structure of a register module, according to one or more embodiments.

The description provided with reference to FIGS. 1A to 2 is generally applicable to FIG. 3.

Referring to FIG. 3, the register module 200 may allocate register cells of a register file (or a register bank) into three portions (or areas). The portions/areas may include the I area (the input area) 310, the W area (the weight area) 330, and the O area (or the output area) 350. There may also be unallocated parts of the register file (not shown), which are parts that are not allocated to these three areas (or portions).

A register file may be configured to have a limited number of register cells (e.g., 16, 32, and 64), for example, which may be set in advance according to a structure of a predetermined computing instruction set. Each of the register cells may be allocated into one of the 3 portions (e.g., the I area 310, the W area 330, and the O area 350).

The W area 330 may be composed of IRC cells 100. For efficiency of resource use, the register module 200 may fixedly allocate the W area 330 and may only allocate the W area 330 to the IRC cells 100.

The register module 200 may further include one or more input area register cells that perform an input area function, and/or may include one or more output area register cells that perform an output area function.

For example, when a separate register for the I area 310 and the O area 350 is added, all register cells may be implemented as IRC cells 100. However, due to the need of the W area 330 to be implemented as IRC cells 100, a portion of registers cells set as the W area 330 may be used as the I area 310 or the O area 350 (since they still function as register cells for storing data). But, if an I area 310 or an O area 350 (that is implemented as a general register cell, i.e., a non-IRC register cell) is allocated to the W area 330, an IRC operation may not be performed in that portion of the W area 330 (due to lack of IRC register cells). However, as necessary, when only a portion of the W area 330 is the IRC cell 100, the register module 200 may perform an IRC operation in the IRC cell 100 and may perform a non-IRC operation in a general register cell (or RC) for a remaining area of the W area 330 that is not the IRC cell 100, and may add an operation result value of the IRC cell 100 and an operation result value of the general register cell.

The O area 350 may be implemented by general register cells. However, since an output of a previous operation may become a weight of a next operation (depending on the overall operation), as needed, the O area 350 may sometimes be implemented by IRC cells 100 (which may perform the next operation). Therefore, when the I area 310 needs to continuously perform an operation in which a result value is accumulated for different input values, the register module 200 may perform an operation of newly storing, in the O area 350, a value obtained by adding (i) a newly calculated I×W value to (i) a previous output value, i.e., O←I×W+O. Alternatively, when an input value of the I area 310 is fed to the W area 330 in a bit-serial method, the register module 200 may perform an operation of newly storing, in the O area 350, a value obtained by adding (i) a newly calculated I×W value to (ii) a value obtained by left-shifting or right-shifting a previous output value, i.e., O←I×W+shift(O).

The I area 310 may store an input value to be multiplied by the W area 330. The I area 310 may be implemented as a portion of a register cell (e.g., existing in the register file) or may be implemented by adding a separate register. Similar to methods performed in in-memory computing, values of the I area 310 may each be fed to the W area 330 in either a bit-serial method or in a bit-parallel method.

As described above, the existing/available register cell portion may be divided into three areas, such as the I area 310, the W area 330, and the O area 350. However, when necessary, a separate dedicated register may be added to the I area 310 or the O area 350, and a new instruction to read and write values into the I area 310 or the O area 350 may be defined. In other words, regarding a method of dividing a single register file into three areas as above, a method of (1) dividing into three areas of I, W, and O, or (2) dividing into two areas of W and O and adding a separate register for I, or (3) allocating to one area of W and adding separate registers for I and O may be used.

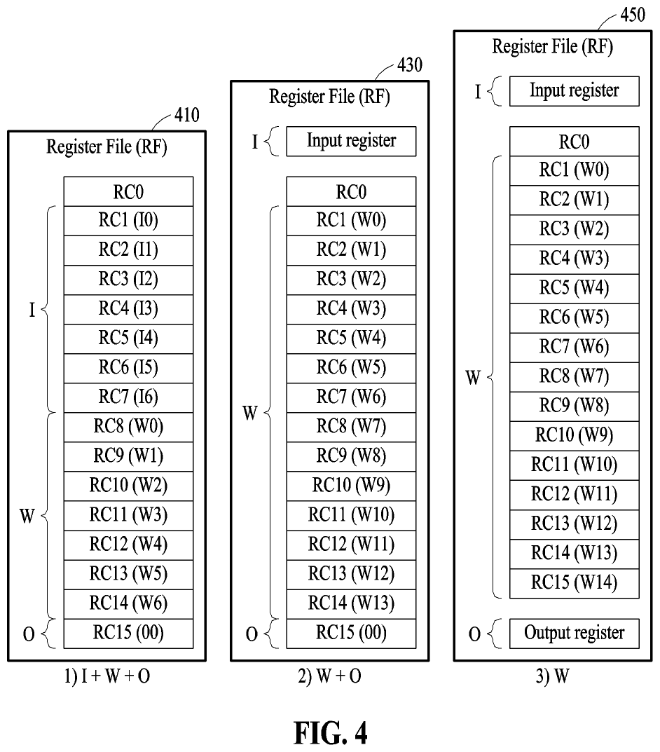

FIG. 4 illustrates an example area allocation method, according to one or more embodiments.

The description provided with reference to FIGS. 1A to 3 is generally applicable to FIG. 4.

The register module 200 may allocate a register file (or a register bank) into three areas.

Referring to FIG. 4, the register file including 16 registers may be categorized into three cases as below. Generally, a first register RC0 may be often used as a special register to which writing may not be possible (including output data (O) for example), so the remaining 15 registers may be divided as follows. For example, in a first case 410 (described above with reference to FIG. 3), seven registers may be allocated to the I area 310, seven registers may be allocated to the W area 330, and one register may be allocated to the O area 350. In this case, the W area 330 (e.g., RC8 to RC14) may consist of IRC cells 100, and when a vector-vector operation instruction is performed, values of the I area 310 (e.g., RC1 to RC7) may be input to the W area 330 and multiplied by the RIC cells 100 of the W area 330; resulting values may be added and stored in the O area 350.

In another example, in a second case 430, only the I area 310 may be implemented as a separate register. As in a third case 450, all registers except RC0 may be implemented as respective sets of IRC cells 100, and the I area 310 and the O area 350 may be composed of separate registers. In general, implementing IRC cells 100 in the register module 200 as in the third case 450 may minimize complexity, but the first to third cases may be selected depending on an implementation need and implemented in various ways.

Since registers other than RC0 may be used for separate unique purposes, the register module 200 may use a general variable storage register or a general temporary register, except for the special-purpose registers, as the I area 310, the W area 330, the O area 350, and the like according to the implementation.

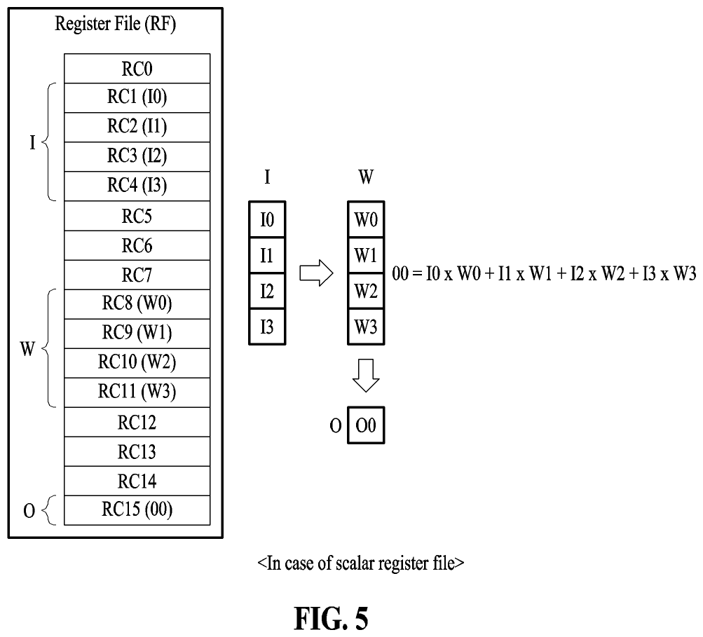

FIGS. 5 to 7 illustrate an example of allocating an area to a scalar register and performing IRC, according to one or more embodiments.

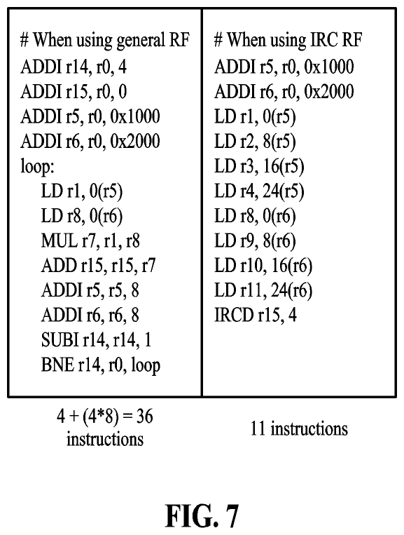

The description provided with reference to FIGS. 1A to 5 is generally applicable to FIG. 7.

It is assumed that a scalar register file of FIG. 5 may not allocate a separate register for the I area 310 and the O area 350 and that existing/available registers may be divided into three areas as in the first case 410.

Referring to FIG. 5, when vector lengths of both an input I and a weight W are 4, the input I may be stored in RC1 to RC4 and a weight value may be allocated to RC8 to RC11. In addition, an output O, which is a result of an operation, may be stored in RC15. According to the implementation, the register module 200 may change allocation areas of the I area 310, the W area 330, and the O area 350, and numbers of allocated registers in the I area 310 and the W area 330 may not be the same. The summation shown in FIG. 5 may be performed by an adder/accumulator described above.

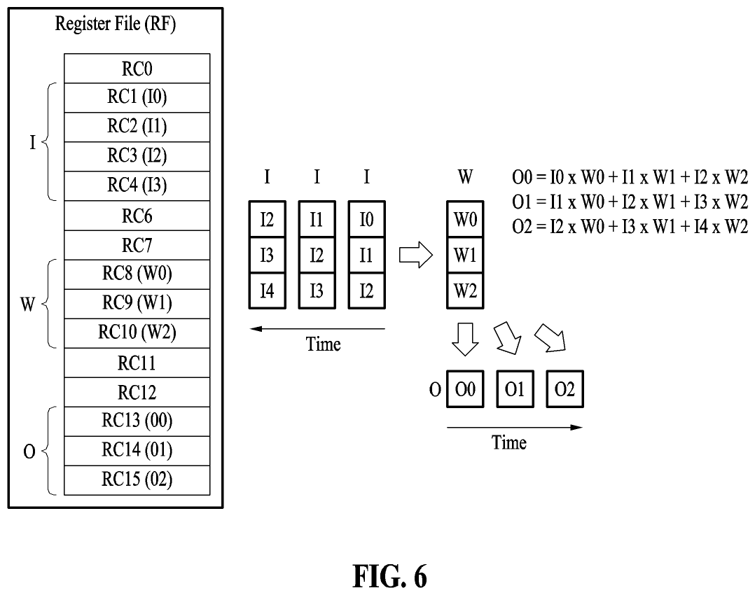

Referring to FIG. 6, when necessary, there may be more registers allocated to the I area 310 than to the W area 330, and a 1×3 convolution operation may be performed using a scalar register to which the IRC cell 100 is applied as shown in FIG. 6.

FIG. 7 shows an example of an amount of computation for an operation where the register module 200 uses a general scalar register file and for the same operation but where the register module 200 uses a register file with IRC cells 100. By using an IRC register file, the number of instructions used for an operation may be greatly reduced (e.g., from 36 instructions to 11 instructions). For example, the IRCD r15, 4 instruction may be an instruction to perform an IRC operation on four double (or 64-bit) data vectors (e.g., r1 to r4 for an input A and r8 to r11 for an input B) and store a result in r15.

The form of instructions may be implemented differently. In addition, different instructions may be included depending on a type of data, and the instructions may be expressed as, for example, IRCB (for an 8-bit data operation), IRCH (for a 16-bit data operation), IRCW (for a 32-bit data operation), and the like. In addition, although an instruction may be performed in a bit-parallel method, the instruction may also be performed in a bit-serial method, in which case a plurality of cycles may be consumed to execute the instruction, so use of a corresponding register file may be limited during the execution of the instruction.

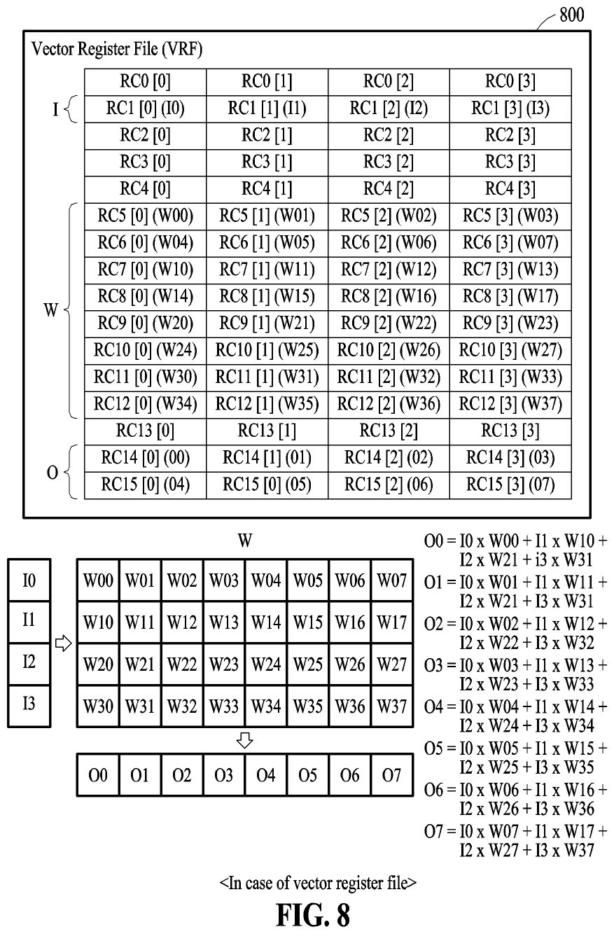

FIG. 8 illustrates an example of allocating an area to a vector register and performing IRC, according to one or more embodiments.

The description provided with reference to FIGS. 1A to 7 is generally applicable to FIG. 8.

Referring to FIG. 8, more cases may arise when area allocation is applied to a vector register. For example, a vector register file 800 may have a total of 16 vector registers, each of which may be of a size for storing four vector elements (e.g., RCN[0] to RCN[3]), divided into three areas, such as the I area 310, the W area 330, and the O area 350, as in the case 410 of 1). IRC using a vector register may also perform a general matrix-vector multiplication (GEMV) operation.

The register module 200 may compare a number of columns of a matrix for the weight value to a number of lanes, where a lane may include at least one of possibly multiple available register banks. The register module 200 may control how many register cells are allocated to the input area and how many register cells are allocated to the output area. The register module 200 may control an operation order of the IRC cell 100 and a method of storing an operation result based on a comparison result.

In the case of a vector register, two cases may be assumed as follows, depending on a number of lanes and a number of columns of weights to be mapped.

Case 1-1) When the number of weight columns is less than or equal to the number of lanes: a minimum number of required input registers==a minimum number of required output registers.

Case 1-2) When the number of weight columns is greater than the number of lanes: the minimum number of required input registers<the minimum number of required output registers.

In the vector register file 800 of FIG. 8, the size of a W matrix is 4×8 and four lanes exist, so the vector register file 800 may correspond to Case 1-2), in which one W row (e.g., W00 to W07) may be stored in two vector registers (e.g., RC5 and RC6). Therefore, 10, which may be an input of the corresponding row, may need to enter RC5 and RC6 together. However, since there may be hardware difficulties for the register module 200 to cover all cases, when the length of rows of the W matrix (which may be the number of weight columns) is longer than the length of the vector register and a single input needs to enter multiple registers, as in Case 1-2), an operation may be performed through several steps.

For example, in the case described above, 10 to 13 may first be input to RC5, RC7, RC9, and RC11, respectively, and an output may be stored in RC14. I0 to I3 may subsequently be input to RC6, RC8, RC10, and RC12, respectively, and an output may be stored in RC15. In this method, four addition devices (e.g., an adder tree) may be implemented to be used sequentially, resulting in efficient use of hardware resources.

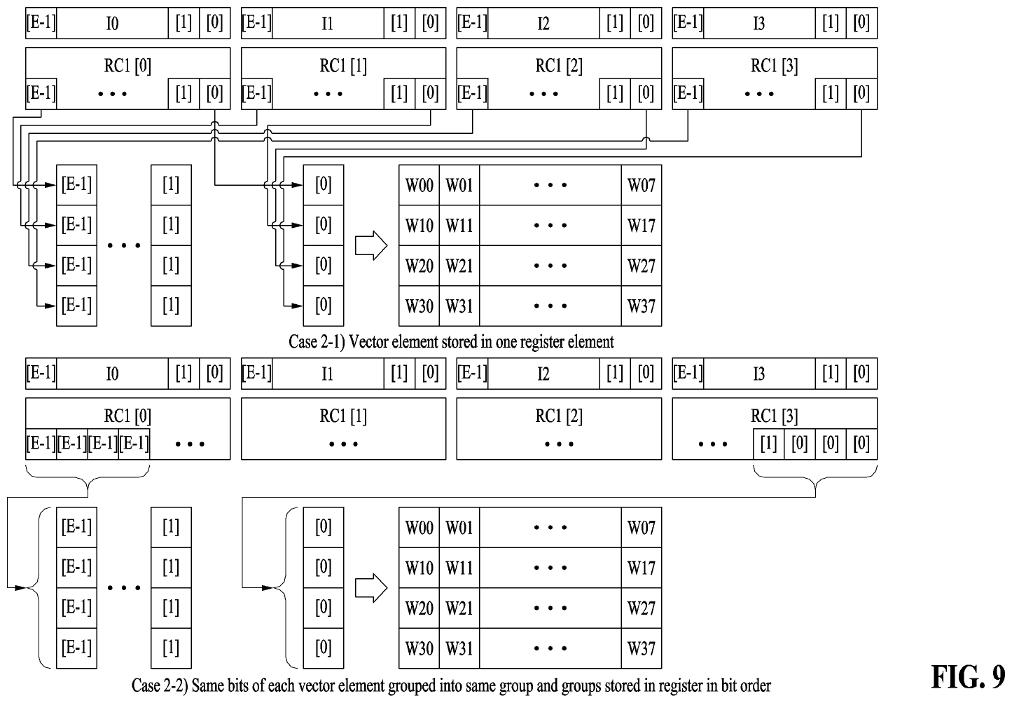

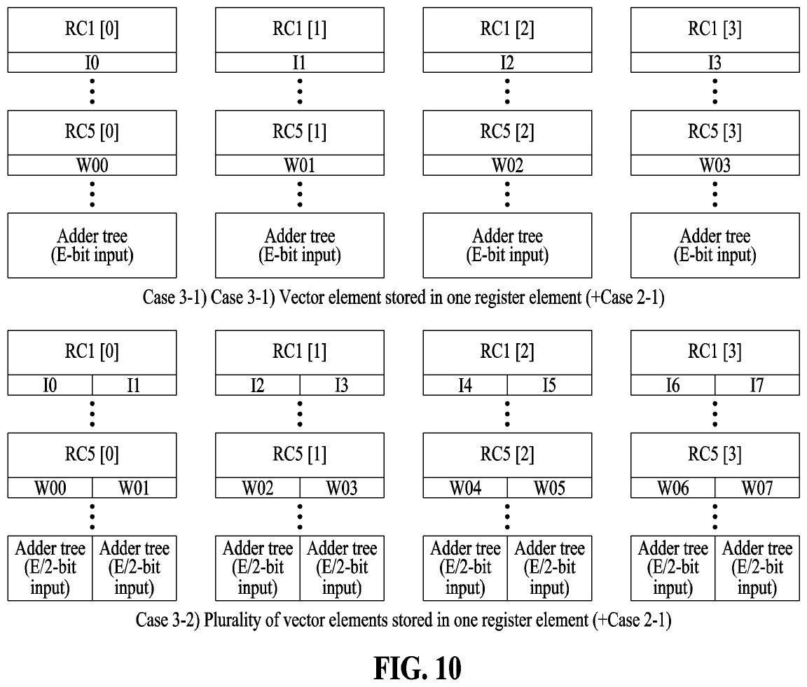

FIGS. 9 and 10 illustrate an example of storing a vector element, according to one or more embodiments.

The description provided with reference to FIGS. 1A to 8 is generally applicable to FIGS. 9 and 10.

Referring to FIG. 9, the register module 200 may control an operation order of the IRC cell 100 and a method of storing an operation result. In addition, the register module 200 may control a method of storing a vector element in an input area and an output area, in response to an operation method of IRC.

For example, when performing a bit-parallel multiplication operation, one vector element may generally be stored in one register element (e.g., RCy[x], E-bit) without a change and also be input as a corresponding row in the W area 330. However, when performing a bit-serial multiplication operation, there may be two cases of a method of storing a vector element in an input/output register area (e.g., the I area 310 and the O area 350). An example of a bit-serial operation from a least significant bit (LSB) to a most significant bit (MSB) is shown in the drawing, but examples are not limited thereto and may also include an MSB to LSB operation.

Case 2-1) One vector element may be stored in one register element.

Case 2-2) Same bits of each vector element may be grouped into a same group, and the groups may be stored in a register in a bit order (e.g., MSB to LSB or LSB to MSB).

In general cases, one vector element may be stored in one register element, as in Case 2-1). In this case, in order to perform a bit-serial operation, an operation of collecting same bits stored in each register element and inputting the collected same bits as a multiplication input of the W area 330 may be needed, and additional logic circuits such as more than one multiplexer (MUX) may be needed for this operation. Here, as a number of registers allocated to the I area 310 as input registers increases, more additional logic may be needed. In this case, when an additional operation, such as using a value stored in an output register allocated to the O area 350 as an input, needs to be performed, the operation may be performed without a separate conversion process.

In Case 2-2), a bit-serial function may be configured with relatively simple logic depending on a size of the W area 330. That is, for RC1, bits as many as the number of registers in the W area 330 may be read as an input in a bit order. In this case, there may be an advantage that as the number of registers allocated to the I area 310 (as the input registers) increases, a relatively small logic burden may occur. However, since data stored in an input register may need to be reformatted in advance for this, there may be a disadvantage in that additional instructions or operations may be needed.

Referring to FIG. 10, the register module 200 may control the number of vector elements to be stored in one register cell, according to an operation method of IRC.

For example, the number of vector elements stored in one register element may also be divided into cases. However, the example in FIG. 10 assumes a case in which a vector element is stored without being split into bit units, as in Case 2-1) described above. The example may be different when a case such as Case 2-2) is assumed.

Case 3-1) One vector element may be stored in one register element.

Case 3-2) Multiple vector elements may be stored in one register element.

In these cases, it is not assumed that the input I and the weight W have different numbers of bits, but they may have different bits as needed. For example, an input register allocated to the I area 310 may store multiple input vector elements in one register element, but a weight register allocated to the W area 330 may store one weight vector element in one register element. In addition, the output register may be configured the same as the input register. However, examples are not limited thereto, and the output vector element stored in the output register may have a larger or smaller number of bits than the input vector element stored in the input register.

The register module 200 may include at least one addition device (e.g., Adder Tree & Accumulate of FIG. 2). The addition device may include a digital adder module, an analog adder module, a separate adder module, or a variable adder module.

The digital adder module may receive N values read according to an operation result through an N-input adder tree and use the N values to perform a GEMV operation.

The analog adder module may read an operation result for multiple rows or multiple cells at once. The analog adder module may read the result by adding results of cells at once into voltage or current through a WL or a BL (an MBL in the example above), which reads a multiplication result.

The addition device may include an additional circuit such as an adder tree. The addition device may be configured to have a separate module for each case described above (i.e., include one E-bit adder tree and two E/2-bit adder trees), and may be configured as one variable adder module that receives variable precision data as an input depending on the settings.

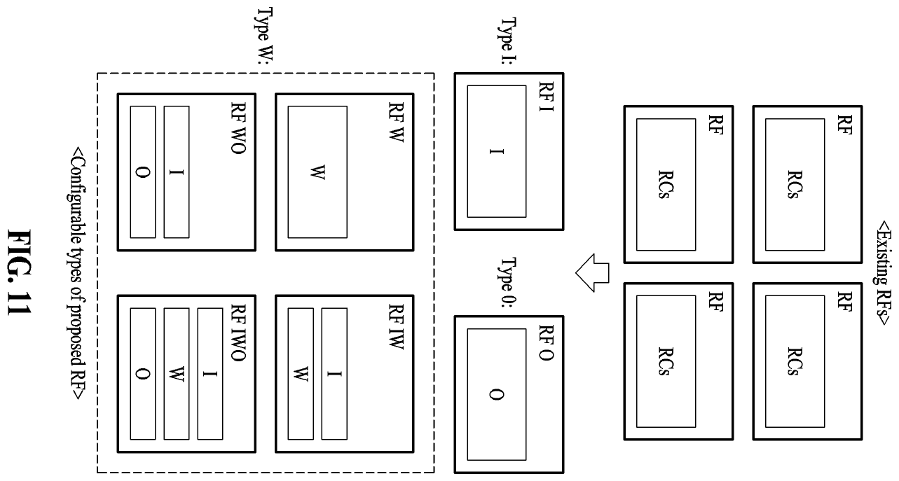

FIGS. 11 to 13 illustrate an example of performing IRC using different types of register modules, according to one or more embodiments.

The description provided with reference to FIGS. 1A to 10 is generally applicable to FIGS. 11 to 13.

Referring to FIG. 11, an IRC device may allocate an input area, a weight area, and an output area using different types of register files. If there are multiple IRC devices, if each of the IRC devices has multiple different threads or cores and each of the IRC devices has a register file, the IRC devices may allocate types (or areas) of the register files differently.

An IRC device based on the IRC cell 100 may configure different roles for different register files existing in the different threads or cores. For example, a register file may be configured as an RF (i.e., register file) I type (e.g., a register file dedicated to the I area 310), which includes only input value I data. Or, a register file may be configured as an RF O type (e.g., a register file dedicated to the O area 350), which includes only output value O data. Here, a register cell of RF I or O type may be composed of IRC cells 100 or may be composed of general (non-IRC) register cells.

In addition, another register file may be configured as a type of RF W, RF IW, RF WO, RF IWO, and the like, which includes input value W data. In order to configure a register file as a type including the W area 330, at least some or all of register cells in the register file may need to be composed of IRC cells 100. Here, the RF IW, RF WO, RF IWO, and similar types may be implemented like the cases 410, 430, and 450 of FIG. 4 and may or may not include a separate input/output register.

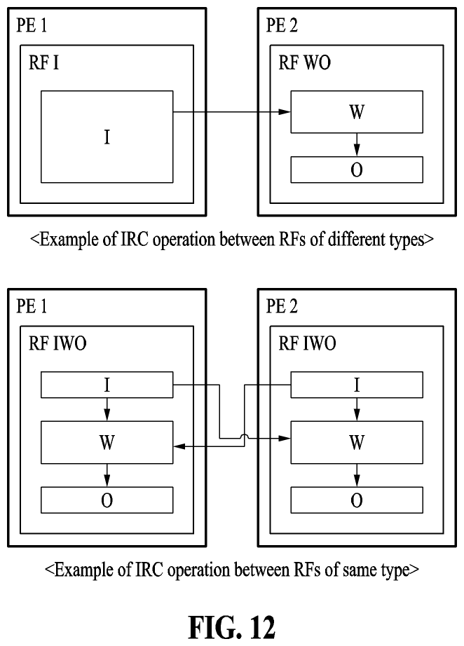

Referring to FIG. 12, an example of an operation between register files of different types and an example of an operation between register files of the same type are shown. For example, an IRC device may operate IRC in a manner such that only input data is stored in an I-type RF in processing element (PE) 1 and is fed to a W portion set in a WO-type RF of PE 2, and a result is stored in an O portion. In another example, PE 1 and PE 2 may be equally composed of IWO-type RFs and may (i) input each I portion to the W portion and store a result in the O portion, or may (ii) input each I portion to the W portion in different RFs and store a result in each O portion. Here, a PE may be an operation unit such as a thread or a core.

When register files in different PEs (e.g., a core or a processor) exist in physically separate spaces, exchanging data between the register files may be inefficient since multiple stages of modules (e.g., an interrupt controller, a bus, and a bridge) may be required. In an IRC device, when register files in different PEs (e.g., a thread or a hart (hardware thread)) have different physical addresses but exist in the same register module 200, data transmission may be relatively easy and efficient implementation may be achieved.

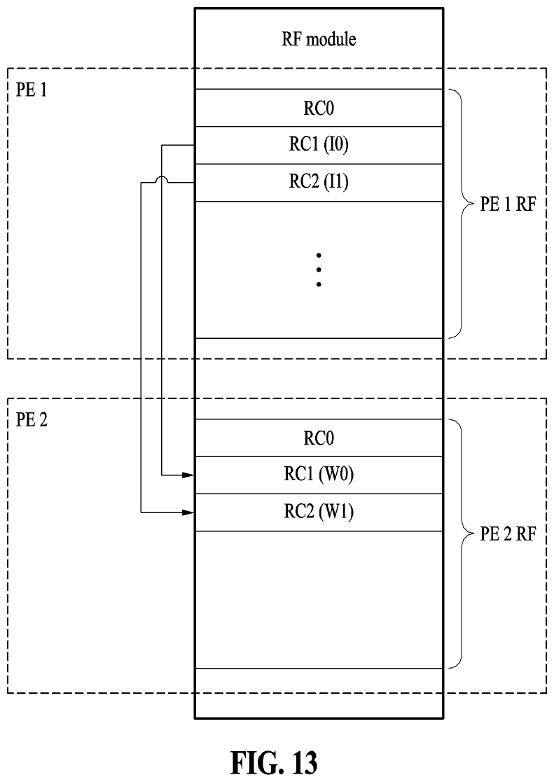

Referring to FIG. 13, when different PEs (e.g., PE 1 and PE 2) exist in the same register module 200 and resources within the same register module (e.g., registers, data, etc.) are allocated to different PEs, and thus have the same logical address (RC0 to RCN) but are accessible through different physical addresses, IRC may be more efficiently performed by defining a new instruction and configuring a decoder. To elaborate, as described above, PEs are independent computational units. While each PE operates independently, PEs may share resources within the same register module. For instance, FIG. 13 shows a scenario where different PEs exist within the same register module, utilizing the same logical addresses but different physical addresses. This facilitates efficient data exchange and computation across PEs. Resources may be managed and assigned in a way that ensures proper operation of independent PEs. Resources within the same register module may be allocated to different PEs, allowing them to operate independently while sharing logical addresses through different physical mappings.

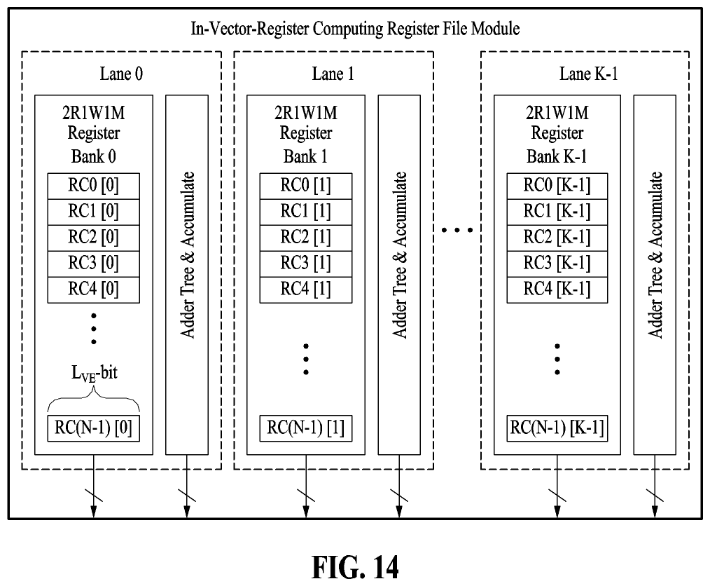

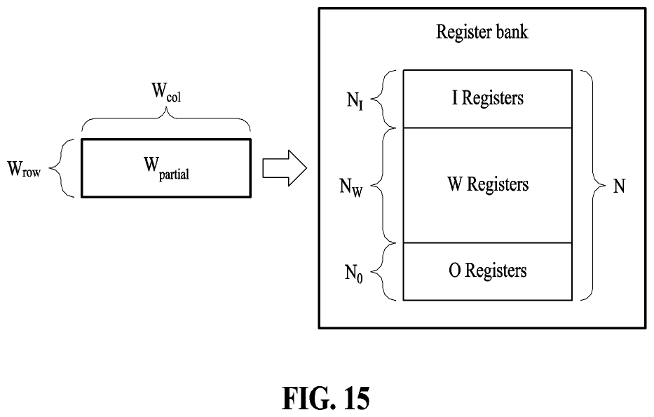

FIGS. 14 and 15 illustrate an example of IRC, according to one or more embodiments.

The description provided with reference to FIGS. 1A to 13 is generally applicable to FIGS. 14 and 15.

Referring to FIGS. 14 and 15 together, conditions to be considered when applying IRC to a vector register may be confirmed. First, each of variables when an IRC cell 100 is applied to the vector register may be confirmed in FIG. 14. Here, a partial weight value (Wₚₐᵣₜᵢₐₗ) that may be stored in the parameterized register module 200 (which includes a register bank) and in the W area 330 at the same time may be confirmed in FIG. 15. The number of lanes of a vector register file module may be assumed to be “K.” Each lane may include one or more register banks, but it is assumed in FIG. 14 that each lane includes one register bank. “N” vector registers may exist in total, a bitwidth of each vector register element may be composed of L_{VE} (i.e., a length of a vector element) bits, and a bitwidth of data elements such as an input and a weight may be assumed to meet L_{DE} (i.e., a length of a data element)=L_{VE}. In addition, in the case of an RF IWO type, each register bank may be composed of “N_{I}” I registers, “N_{W}” W registers, and “N_{O}” O registers, and numbers of rows and columns of the partial weight Wₚₐᵣₜᵢₐₗ that may be written to the W area 330 at one time may be set to “W_{row}” and “W_{col},” respectively.

In the above case, relationships between each of the variables may be summarized in Equations 1 to 4 as follows.

$${N}_{I} + {N}_{W} + {N}_{O} = N \qquad Equation 1$$

$$( {W}_{c o l} / K ) \leq {N}_{O} \qquad Equation 2$$

$$\frac{( {W}_{row} \times {W}_{col} )}{K} \leq {N}_{W} \to {N}_{O} \leq {N}_{W} \qquad Equation 3$$

$$Ceil ( \frac{{W}_{row}}{K} ) \leq {N}_{I} \qquad Equation 4$$

Equation 1 is for an RF IWO-type register bank and may be different when the I area 310 or the O area 350 is configured as a separate register.

In Equation 2, a value obtained by dividing the number of columns of the partial weight Wₚₐᵣₜᵢₐₗ to be stored in the W area 330 by “K,” the number of lanes of the vector register file module, may need to be less than or equal to the number of output registers and less than or equal to a number of weight registers. Since a size of an output value for one input value of size 1×W_{row} may be 1×W_{col}, in order for the output value to be efficiently stored in the output register, Wool may need to be less than or equal to a size of “No” registers composed of “K” elements.

In addition, since the Wₚₐᵣₜᵢₐₗ value needs to be stored in the W area 330, Equation 3 may need to be true. Here, since a value of W_{row} may be greater than or equal to 1, a size of N_{W} may be greater than or equal to No.

Lastly, as shown in Equation 4, a value obtained by dividing W_{row} by “K” and rounding up may need to be less than or equal to a number of input registers. When N_{I} is 1 (since W_{row} is greater than “K” and Ceil (W_{row}/K) has a value of 2 or more), the entire GEMV operation may not be performed efficiently. Thus, for a GEMV operation to be performed efficiently, Equation 4 may need to be true.

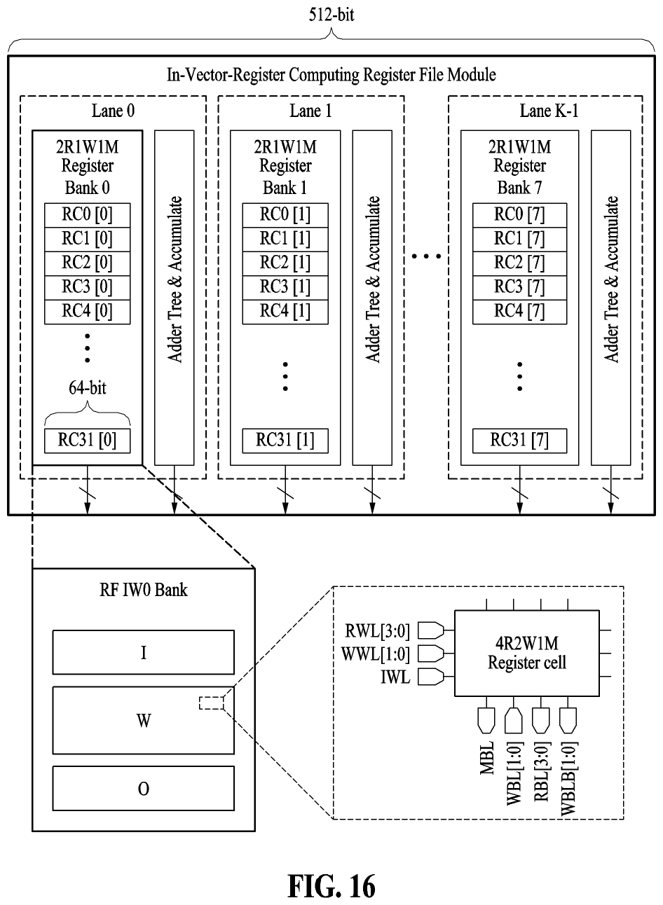

FIGS. 16 to 19 illustrate examples of performing IRC in a vector register, according to one or more embodiments.

The description provided with reference to FIGS. 1A to 15 is generally applicable to FIGS. 16 to 19.

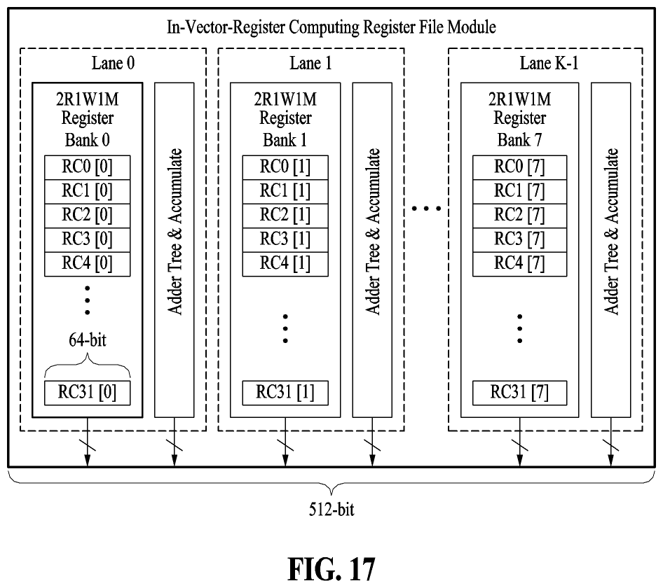

Referring to FIGS. 16 and 17, an operation of an IRC device may be performed in a vector register. In general, a vector register may be composed of at least one lane, and one lane may include at least one register bank and at least one addition device (e.g., the at least one addition device of FIG. 2). In an example, the vector register module 200 may be configured with one register bank per lane and may have a total of K=8 lanes. Each of register banks may be composed of at least one vector register, and the example described may be a structure composed of a total of N=32 vector registers. That is, the vector register file of the example described herein has a structure in which N vector registers each include K vector elements, and a bitwidth of each vector element is configured to have LVE=64 bits. In general, the bitwidth LVE of vector elements or the bitwidth LDE of data elements such as an input and a weight may be composed of 16 bits, 32 bits, 64 bits, and the like.

The register module 200 may assume each of the register banks to be a register file IWO type, and each of the register banks may include register cells allocated into three areas (e.g., the I area 310, the W area 330, and the O area 350). Here, the W area 330 may include IRC cells 100 capable of performing an IRC operation. FIG. 16 illustrates an example of the W area 330 composed of 4R2W1M register cells, each of which has four read ports, two write ports, and one multiply port.

Referring to FIG. 13 also, an example of a register file module in the case of K=8, N=32, and LVE=64 is shown in FIG. 16. In the register module 200, each register bank may be an RF IWO type, and the total number of registers, 32, may be configured to meet I:W:O=8:16:8 to satisfy Equations 1 to 4. That is, RC0 to RC7 may be allocated as the I area 310 to be an input register, RC8 to RC23 may be allocated as the W area 330 to be a weight register, and RC24 to RC31 may be allocated as the O area 350 to be an output register. Thus, here, RC8 to RC23 may include the IRC cell 100, and vector elements in the W area 330 may store a weight of 64-bit size, which has the sizes (16×8), (8×16), (4×32), or (2×64). A weight having the size (1×128) may be stored and used in performing an operation, but in this case, the condition of Equation 2 may not be satisfied. When one input register element value is input to each of RC8 to RC23 of the W area 330, the output may be 1×128=1×8×16, so 16 registers of 1×8 length may be needed. Since there are only 8 output registers, inefficiencies may occur when performing an operation, such as dividing in half, storing intermediate results in a memory, and reloading. Thus, types of operations that may be performed may be assumed to be operations on four types of weights, as shown in Table 1.

TABLE 1

| E = 64 | I | W | O |
|---|---|---|---|
| Operation 1) | (1 × 16)~(4 × 16) | (16 × 1)~(16 × 8) | (1 × 1)~(4 × 8) |
| Operation 2) | (1 × 8)~(8 × 8) | (8 × 1)~(8 × 16) | (1 × 1)~(4 × 16) |
| Operation 3) | (1 × 4)~(8 × 4) | (4 × 1)~(4 × 32) | (1 × 1)~(2 × 32) |
| Operation 4) | (1 × 2)~(8 × 2) | (2 × 1)~(2 × 64) | (1 × 1)~(1 × 64) |

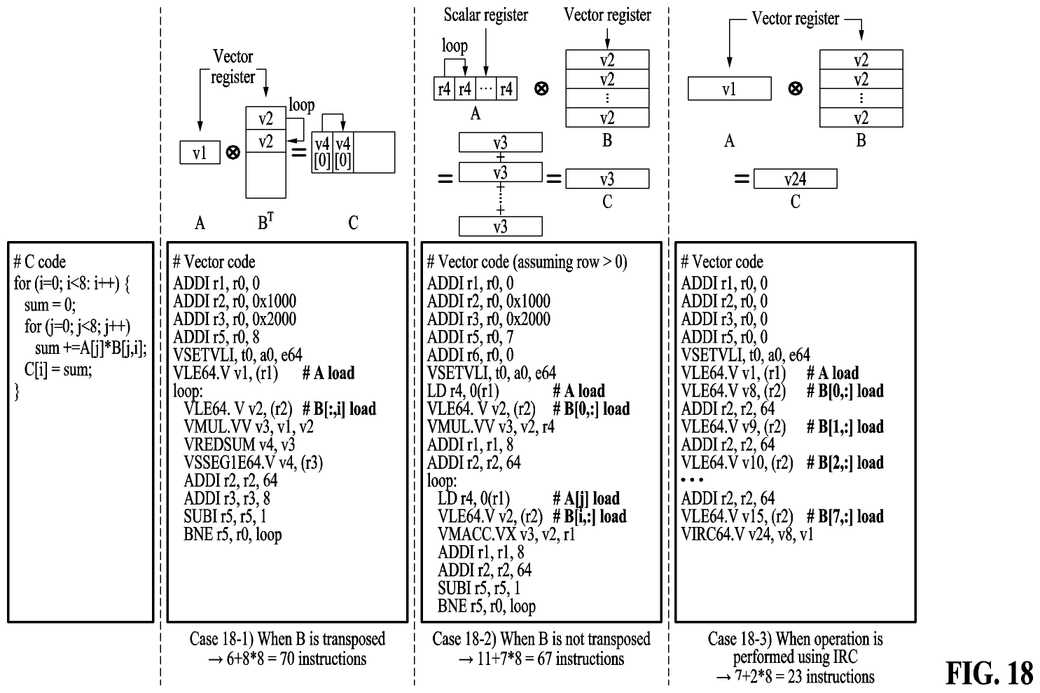

For example, referring to Operation 2) type in Table 1, a difference in an instruction compilation, for operation code of the case I: (1×8), W: (8×8), O: (1×8), between a method using an vector register and a method using the IRC cell 100 may be confirmed in FIG. 18.

Code may be compiled with a vector extension of reduced instruction set computing (RISC)-V, as a non-limiting example, according to descriptions here. C code may be compiled in a different way from the example, or using a different instruction set architecture (ISA).

Referring to FIG. 18, a vector register may multiply an input vector A (or I) of size 1×8, each element of which is of 64-bit size, by a weight matrix B (or W) of size 8×8 to obtain an output vector C (or O) of size 1×8.

When using a conventional vector register, two cases may occur, such as Case 18-1) and Case 18-2).

For example, in Case 18-1) a transpose of the matrix B has been previously obtained and stored in a memory. In this case, the input A and the matrix B may be loaded into the vector register, each element may be multiplied through VMUL.VV, and a result may be reduced to one value through VREDSUM to obtain one element of the output vector C. In Case 18-1), the operation may be performed by loading all input values into the vector register, but a transpose value for the matrix B may need to be obtained and stored in a memory, or, an operation of obtaining the transpose value for the matrix B may need to be added before performing the operation.

In another example, in Case 18-2) the transpose value for the matrix B is not obtained and a value of the matrix B itself is used. In order to obtain a value of the output vector C for each element, as in Case 18-1), a very inefficient access to the stored value of the matrix B may need to be performed, so it may take a long time to read the value of the matrix B from a cache memory. Thus, in Case 18-2), rather than performing an operation for the value of the output vector C for each element, vector registers may perform an operation by continuously calculating a partial sum of the entire output vector C to obtain a final output value. However, in Case 18-2), an operation required in the vector registers may be a vector-scalar operation rather than a vector-vector operation. Thus, values may be read by loading the input vector A from a scalar register and the weight matrix B from a vector register, and an operator may perform an operation using a VMACC.VX instruction and may subsequently store a result.

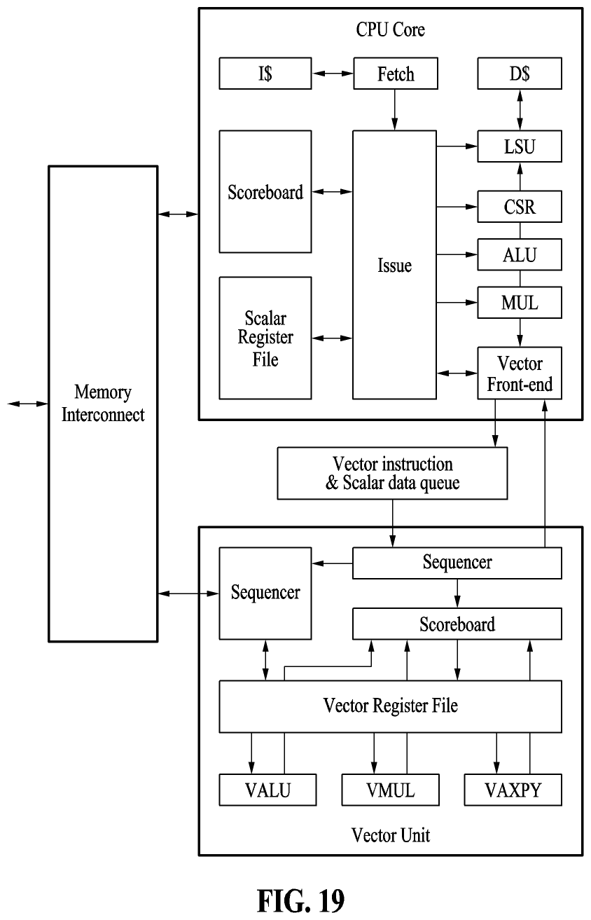

Referring to FIG. 19, the difference between (i) a method of loading the input vector A from the scalar register and loading the value to perform an operation and (ii) a method of obtaining the transpose of the matrix B, both of which are through the operation method that uses a RISC-V core and a vector unit, may be compared.

In the RISC-V core issue, when an instruction is determined to be a vector instruction, the vector instruction may be transferred to an instruction queue, which may be transferred to a vector unit through a vector front-end module. Here, the vector front-end module may send the instruction in a speculative manner, but when the instruction includes a scalar register value, the vector front-end module may wait, referring to a scoreboard module, until no issue such as a hazard exists, to send the scalar register value to the instruction queue. In other words, in this case, the instruction may be transferred in a non-speculative manner, and for a specific micro architecture implementation or application code, Case 18-2) may have fewer instructions but consume more cycles than Case 18-1).

Referring again to FIG. 18, in Case 18-3), which uses a vector register to which the IRC cell 100 is applied, the non-transposed weight matrix B value may be loaded (without a change) into the W area 330 of the vector register file (VRF), and the vector register may perform an IRC operation using the input vector value loaded into the I area 310 of the VRF. In Case 18-3), the example described herein has introduced newly defined instructions such as VIRC64.V vd, vs2, and vs1. The new instructions may perform an IRC operation on “v1” vectors starting from an address vs2 of the W area 330 and a value stored at an address vs1 of the I area 310, based on a vector length (v1) value preset through the VSETVLI instruction, and may subsequently store an operation result in an address vd of the O area 350.

Unlike in Case 18-1), in Case 18-3), the weight matrix B value may not need to be transposed in advance, the input vector A may not need to be loaded from the scalar register, and a number of compiled instructions may be less than in Case 18-1). However, when an VIRC operation is implemented in a bit-serial method, each element bitwidth may increase as an operation is performed by internally decoding a VIRC instruction as a micro operation and accordingly cycle consumption may proportionally increase. However, when using the IRC cell 100, the total number of instructions may be reduced, and the operation may be performed in the VRF without using a separate external operator when performing an IRC operation. Therefore, when the IRC cell 100 is combined with a plurality of hart (hardware thread) structures, when one VRF is performing an IRC operation, other VRFs sharing an external operator may operate an operator such as ALU, MUL, and the like without any problem. Therefore, VRFs to which the IRC cell 100 is applied may perform a general operation and an IRC operation separately, thereby greatly increasing overall operation throughput.

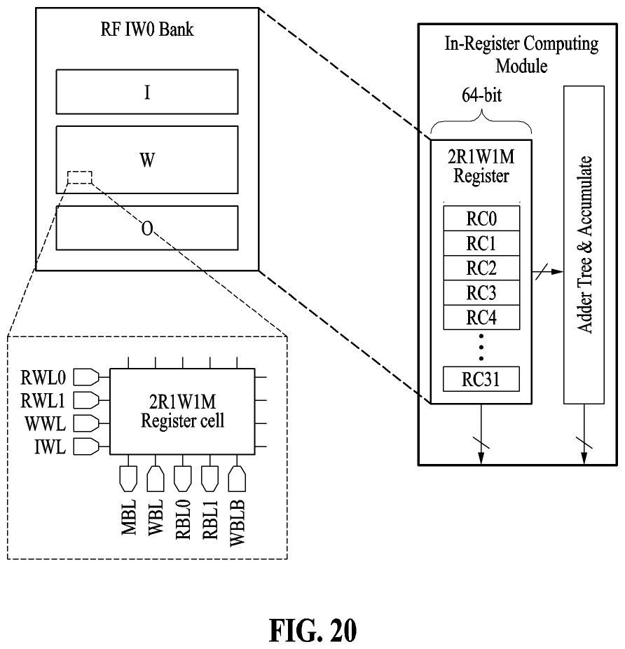

FIG. 20 illustrates an example of performing IRC on a scalar register file, according to one or more embodiments.

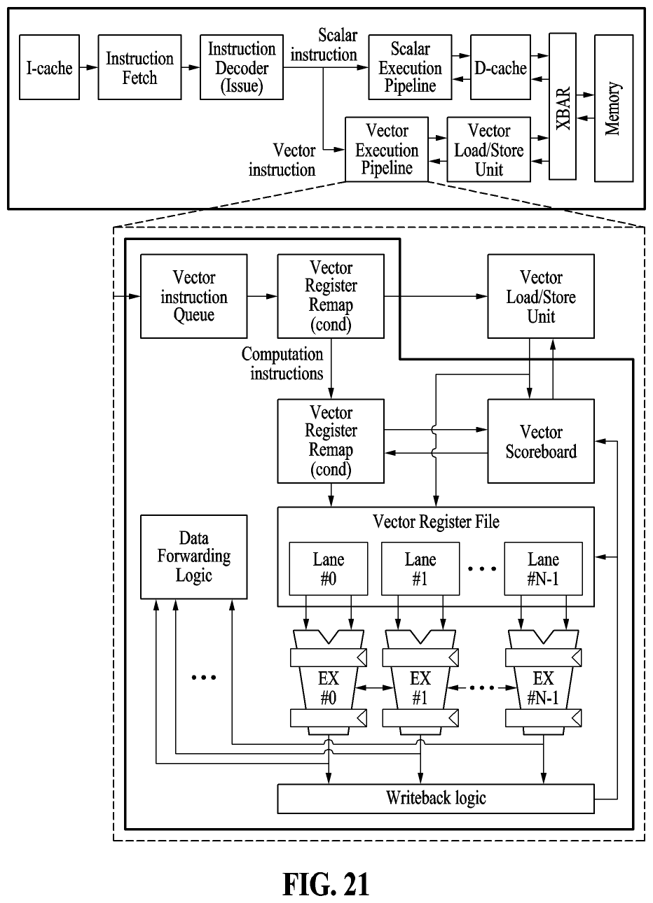

The description provided with reference to FIGS. 1A to 19 may apply to FIGS. 20 and 21.

Referring to FIG. 20, a difference between using the IRC cell 100 in a scalar register and using the IRC cell 100 in a vector register may be understood. When applying an IRC cell 100 to a scalar register, it may generally be more efficient to perform only a vector-vector operation instead. There may be a special-purpose register, such as RC0, or some other registers that need to perform predetermined roles. That is, the total number of allocated registers in the I area 310 and the W area 330 may be the same, or the I area 310 may need to have a slightly larger number of allocated registers to perform a simple convolution operation as shown in FIGS. 5 and 6.

Next, for comparison, operation of a non-IRC vector register and an operation of in-memory computing are described.

FIG. 21 illustrates an example of a vector register, according to one or more embodiments.

One or more blocks of FIG. 21 and a combination thereof may be implemented by a special-purpose hardware-based computer that performs a predetermined function or a combination of computer instructions and special-purpose hardware.

A vector register may store multiple data elements at once, and each data element may generally have a fixed size. For example, a 128-bit vector register may store sixteen 8-bit data elements, eight 16-bit data elements, four 32-bit data elements, or two 64-bit data elements. The size of the vector register may vary depending on a structure and design of a CPU, and a bit length and a number of data elements in the vector register may be changed during operation.

A vector register may allow parallel processing by allowing operations on multiple data elements to be performed simultaneously. For example, a vector register may be used to efficiently perform multiple-pixel image processing, audio signal processing, scientific and engineering calculations, and the like. A vector register may allow quick performance of repetitive calculations or a same operation on a set of data, and a vector operation may be performed using an instruction set that supports a single instruction, multiple data (SIMD) operation.

The number of cycles taken to load data into a register may vary depending on the architecture of a CPU. Typically, the time taken to load data into a register may be very short, and in a CPU, loading data into a register may be processed in only one or several cycles.

However, the number of cycles may vary depending on a structure and technical factors of the CPU. A high-performance CPU may use a pipeline or superscalar structure to process multiple instructions simultaneously and to minimize the number of cycles taken to load data. In addition, various optimization techniques may be used in a CPU, such as using cache memory to improve memory access speed.

Thus, the time taken to load data into a register may generally be very short and may thus be expressed in the unit of cycles. Since most CPUs load data into a register immediately while a load instruction is being executed, additional cycles may not be needed. However, the total processing time may be determined by various factors such as CPU clock speed and pipeline delay.

In a vector register, the time taken to load data may be longer than in the case of general registers. However, by using a separate Vector Load/Store Unit (VLSU) and the like, a path to retrieve data quickly from a memory may be used, and a task of loading data into a vector register or storing data back in the memory may thus be accelerated.

FIG. 21 illustrates an execution pipeline structure of a CPU that uses a vector register and a vector operation unit, according to one or more embodiments. FIG. 21 illustrates an operation structure of a CPU having a general scalar execution pipeline and a vector execution pipeline.

Referring to FIG. 21, the CPU may have a five-stage execution pipeline, such as Instruction Fetch-Instruction Decode-Execute-Memory Access-Writeback. When an instruction interpreted in the Instruction Decode stage of the main pipeline is a vector instruction, the instruction may be transferred to a vector execution pipeline.

In the first stage of the vector execution pipeline, a vector instruction may be stored in a buffer (or an instruction queue), and when the corresponding processor supports an out-of-order operation, the vector instruction may pass through a Register Remap module. On the contrary, when the processor supports only a sequential (or in-order) operation, the instruction may be transferred to Vector Instruction Decoding. Subsequently, the interpreted instruction may access the vector register, and the vector register may determine a length of each vector element, a number of components of the vector element, and a number of registers to read, according to values set in a preset control and status register (CSR). In general, a VRF may be composed of a plurality of register banks, and usually at least one register bank may be allocated to one lane. That is, the vector register may provide data to an operation unit in which at least one register bank exists in one lane.

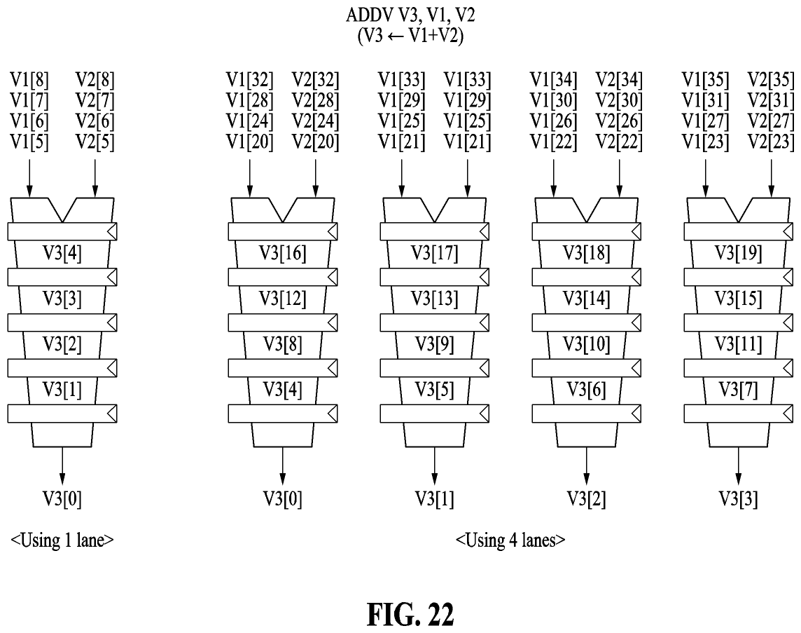

FIG. 22 illustrate an example of an operation of a vector execution pipeline.

The description provided with reference to FIG. 21 may apply to FIG. 22.

Referring to FIG. 22, while the execution stage of a general scalar execution pipeline may be composed of about one cycle, the execution stage of the vector execution pipeline may be divided into multiple cycles to perform an operation. When the vector execution pipeline uses a deep pipeline structure, an operation may be divided so an operation clock frequency may increase and multiple operations may be performed in a short time. In addition, in the case of a vector operation, a deep pipeline structure may be used because each element may generally be independent of each other, and accordingly a relatively simple circuit configuration may be possible. When necessary, different operations may be configured to be performed in different stages, respectively, so that various complex operations may be performed.

For example, when using a 5-stage execution pipeline, when an operation is to be performed on vectors with a total 64 elements in 1 lane, a total of 5+63=68 cycles may be needed. In addition, a vector operation is to be performed on vectors having 64 elements in 4 lanes, a total of 5+15=20 cycles may be needed.

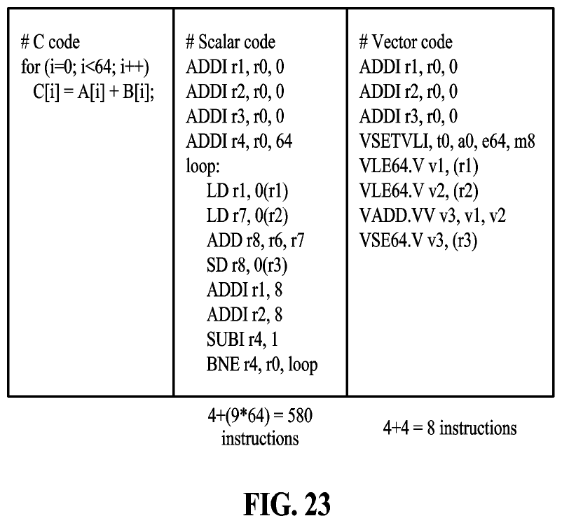

FIG. 23 illustrates an example of a vector operation instruction, according to one or more embodiments.

The description provided with reference to FIGS. 21 and 22 is generally applicable to FIG. 23.

Referring to FIG. 23, an advantage of a vector instruction-based method may be that a vector-vector operation may be performed using fewer instructions than anscalar instruction-based method. Thus, the vector instruction-based method may reduce the Instruction Fetch—Instruction Decode process.

For example, when a vector addition operation with 64 elements is to be performed in RISC-V, the scalar instruction-based method may need a total of 580 instructions, while the vector instruction-based method may perform the same operation with a total of 8 instructions. In other words, an ADD operation on 64 elements may be performed through one vector instruction VADD.VV.

The time taken to perform the above operation in a vector processor may be as follows (assuming the vector register to be 512 bits). First, setting the vector register r1, r2, r3 values and setting through vsetvli may each take only one cycle. Here, the time taken to read/write a vector between registers/memory may be important.

Cache line size of a general L1 data cache may be 64 bytes. When the data size of one vector element is assumed to be 64 bits (i.e., e64), the number of elements included in one cache line may be 8. When a vector performing the calculation includes 64 elements, one vector may be stored in a total of 8 vector registers (i.e., m8), and the time taken to load the vector from the cache to the vector register may be 8 cycles. Thus, in the above example, a total of 16 cycles may be consumed to load v1 and v2. The time taken to perform a subsequent VADD.VV operation may vary depending on the total number of vector operation units in the corresponding vector processor. When a vector processor has a total of 8 lanes and may thus perform operations on 8 elements simultaneously, the time required to perform the operations may be 8 cycles (8×8=64). Subsequently, storing a vector value v3 back in a memory may take 8 cycles. Therefore, when assuming the cache line size to be 512 bits, the element size to be 64 bits, the vector size to be 64 elements, and the number of lanes to be 8 lanes, the total time taken to perform the entire operation may approximately be 2 (for Instruction Fetch and Instruction Decode)+32 (for Execute)+2 (for Memory Access and Writeback)=36 cycles.

When a multi-stage execution pipeline is used as shown in FIG. 22, the number of cycles may increase further. For example, when a 5-stage execution pipeline is used, a total of 41 cycles may be required. Compared to the scalar instruction-based method, which requires about 584 cycles to perform the operation, the number of cycles consumed is significantly reduced.

A conventional CPU may be affected in terms of data processing time for the following reasons. 1) A CPU with a limited number of registers may have a limited number of storage spaces, which may cause inefficiency when a program needs to process a large amount of data, as the data may need to be moved to a memory due to insufficient register capacity. 2) The CPU may improve memory access speed using a cache memory. However, when loading data, when the corresponding data is not in the cache, a cache miss may occur. In this case, data may need to be retrieved from a memory, which may cause a delay and degrade execution performance of the program. 3) For parallel processing, the CPU may process multiple instructions simultaneously. Here, when two or more instructions try to access the same register at the same time, a register file conflict may occur. When a conflict occurs, execution of the instructions may be delayed, or an error may occur. 4) The CPU may process multiple instructions simultaneously using a pipeline. A pipeline may refer to technology that divides an instruction execution process into stages for processing. A pipeline may consist of several stages, and each stage may perform one instruction execution stage. Each stage may operate independently and may be designed to process another stage of another instruction at the same time. However, a pipeline stall may occur in a situation such as branch misprediction of an instruction having dependency. This may also slow down the execution speed of the instruction and degrade performance of the program. 5) Register dependency may occur when the execution of one instruction depends on a result of the execution of another instruction. In order to execute an instruction having register dependency, a value of a corresponding register may need to be prepared, which may delay instruction execution. When the instruction having register dependency is executed immediately without delay in instruction execution, a hazard (e.g., a data hazard and a control hazard) may occur and accordingly, separate logic may be required to handle the hazard.

Referring to the Reasons above, Reason 1) may be due to limited register capacity, which may be solved by using more registers or cache. Reason 2) may be a problem caused by limited register capacity or incorrect register use, and may be solved by increasing the register capacity, changing a data transmission policy between registers and cache, or changing a data structure in terms of software. Reason 3) may be solved by configuring multiple register sets or increasing read/write ports of a register. Reasons 4) and 5) may be related to processor core performance and may be new problems that inevitably arise when a pipeline structure is adopted to increase an operating frequency of a processor and process multiple instructions simultaneously. The register dependency or pipeline delay issues are obstacles to achieving maximum performance of an implemented pipeline structure, and in order to overcome these issues and maximize performance, improved complex logic (e.g. Data forwarding, Interlock, Stall, Scoreboard, and Branch prediction modules) may additionally be needed.

In a CPU that additionally uses a vector register and a vector operation unit, the vector register may have a longer length (e.g., 128 bits, 256 bits, 512 bits, or longer) than a general register (e.g., 32 bits or 64 bits), and when one vector includes a large number of elements and bits, an operation may need to be processed in the vector operation unit by reading multiple vector registers. In addition, when the number of vector elements is greater than the number of operation units, the operation may need to be performed over several cycles. Under the condition stated above (cache line size=512 bits, element size=64 bits, vector size=64 elements, and number of lanes=8 lanes), 8 cycles may each be consumed for loading/storing of a vector. Increasing the number of operation units may reduce the number of cycles, but this may consume even more area and power, so it may be necessary to configure with an appropriate number.

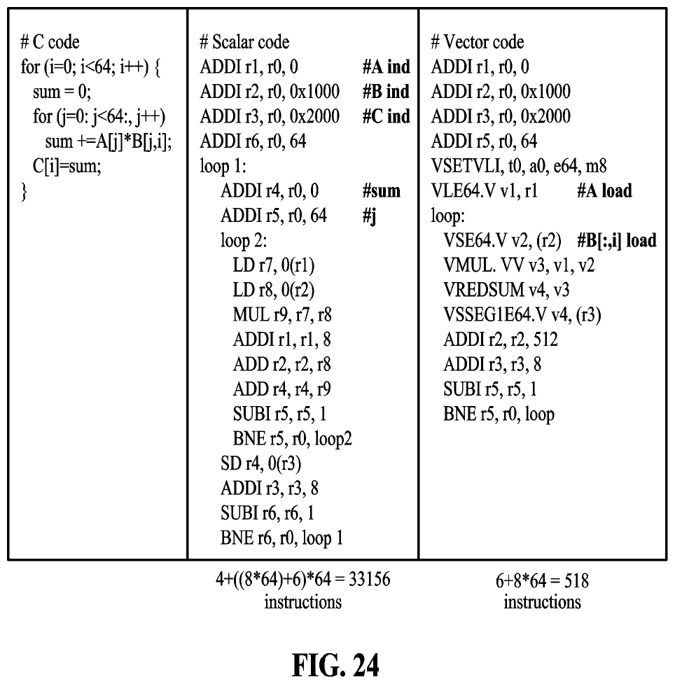

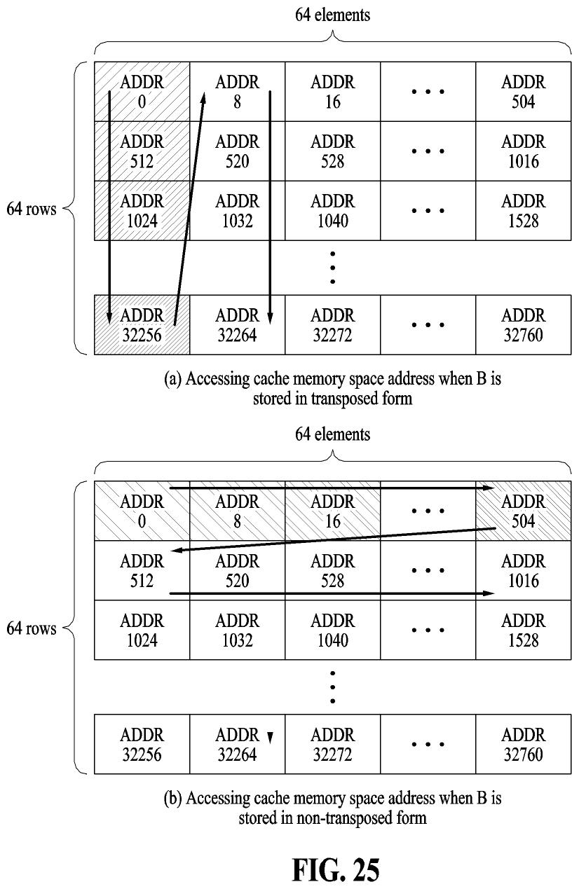

FIGS. 24 and 25 illustrate an example of an instruction in a vector-matrix multiplication operation, according to one or more embodiments.

Referring to FIGS. 24 and 25, in the case of a vector processor including a vector operation unit, in order to perform a vector-matrix multiplication or addition operation, the matrix may need to be divided into vectors and the operation may be performed through a vector-vector operation loop.

For example, a GEMV operation that derives a (1×64) vector result as a result of multiplying a (1×64) vector with a 64-bit element and a (64×64) matrix may be assumed. (The matrix B may be assumed to be transposed and stored in a memory space.) A quantity of 33, 156 instructions may be needed to perform the operation through a scalar instruction, while only 518 instructions may be needed to perform the operation through a vector instruction. However, the important point here may be that in order for the operation to be performed as above, the matrix B may need to be prepared in the memory space in a transposed form, not in its original form. Here, since elements of a matrix are usually stored sequentially in a row in a serial memory space, when the elements are stored in the memory space of the matrix B that is not transposed, in order to perform the operation as shown in FIG. 6, instead of reading values (e.g., ADDR 0, ADDR 8, ADDR 16, . . . ) through a general vector load VLE64.V, B[:,0] vectors (e.g., ADDR 0, ADDR 512, ADDR 1024, . . . ) needed for an operation with a matrix A may need to be loaded through a stride load VLSE64.V. When reading values from a vector register in this way, the probability of an L1 cache miss occurring may be significantly high and accordingly, performance may degrade due to a cache miss each time each element is loaded and an actual execution cycle may be greatly lengthened (i.e., when a miss does not occur, a VLE64.V execution time may be several to tens of cycles, and when a miss occurs, a VLSE64.V execution time may be hundreds to thousands of cycles). Thus, in order to efficiently perform an operation such as GEMV and general matrix multiply (GEMM) using the vector processor, data of the matrix B may need to be transposed and stored in advance before starting the operation. However, since the transpose itself may have an operational complexity of O(n\hat{ }2), tens to hundreds of cycles of operation time and a large amount of buffer or memory may be required. Thus, when the vector processor performs an operation such as GEMV or GEMM using a vector operation unit, it may be more efficient than a basic scalar-based operation, but it may not be an efficient method at a general level.

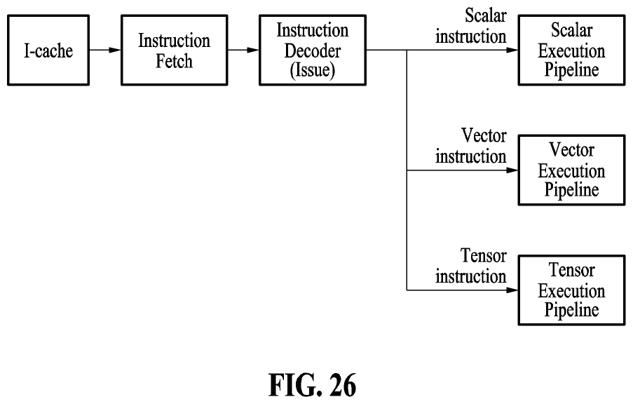

FIG. 26 illustrates an example of a vector operation to which a tensor execution pipeline is added, according to one or more embodiments.

Referring to FIG. 26, a tensor execution pipeline using a separate tensor operation unit may be newly configured to perform a vector-matrix operation, a matrix-matrix operation, and an operation using a tensor (i.e., a matrix of two dimensions or more). After an instruction decoding process, when the instruction is a tensor-related instruction, the instruction may be sent to the tensor execution pipeline to perform an operation. The tensor execution pipeline may usually include an accelerator specialized for a tensor operation, and an example of the accelerator may be a PE-based array or an in-memory computing module.

However, having a separate execution pipeline may not only consume significant resources, such as area and power, but it may also create burdens such as generating and monitoring additional control signals. In addition, an operation performance cycle may differ between different execution pipelines, which may increase additional difficulties in instruction scheduling or handling a hazard.

The computing apparatuses, the electronic devices, the processors, the memories, the information output system and hardware, the storage devices, and other apparatuses, devices, units, modules, and components described herein with respect to FIGS. 1-24 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-24 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An in-register computing (IRC) device comprising:
a register module comprising a register bank and an addition device, the register bank comprising register cells, the register cells including IRC cells,
wherein the register module is configured to allocate first of the register cells to an input area, second of the register cells to a weight area, and third of the register cells to an output area, wherein
the input area is an area in which the register bank stores an input value,
the weight area is an area comprising one of the IRC cells configured to perform an IRC operation between the input value and a weight value, and
the output area is an area configured to store an output value obtained by performing an addition operation on an operation result of the IRC operation using an addition device.

2. The IRC device of claim 1, wherein the register module further comprises:
a register cell allocated to the input area configured to perform a function of the input area; or
a register cell allocated to the output area configured to perform a function of the output area.

3. The IRC device of claim 1, wherein the register module is further configured to:
compare a number of columns of a matrix of the weight value to a number of lanes, wherein a lane includes the register bank; and
based on the comparing, control a number of the register cells to be allocated to the input area and a number of the register cells to be allocated to the output area.

4. The IRC device of claim 3, wherein the register module is further configured to:
control an operation order of the one of the IRC cells and control a method of storing the operation result based on a result of the comparing.

5. The IRC device of claim 1, wherein the register module is further configured to:
control a method of storing a vector element in the input area and the output area based on an operation method of the IRC device.

6. The IRC device of claim 1, wherein the register module is further configured to:
control a number of vector elements to be stored in one of the register cells, based on an operation method of the IRC device.

7. The IRC device of claim 1, wherein the IRC device is configured to:
allocate the input area, the weight area, and the output area using different types of register files.

8. The IRC device of claim 1, wherein the register module comprises a scalar register, a vector register, or a floating register.

9. The IRC device of claim 1, wherein the IRC device is configured to track which of the register cells are allocated to which of the areas and control the register bank accordingly.

10. The IRC device of claim 1, wherein the IRC cells comprise respective operators configured to perform operations between data stored in the IRC cells and other of the register cells.

11. The IRC device of claim 1, wherein the addition device comprises a digital adder module, an analog adder module, a separate adder module, or a variable adder module.

12. The IRC device of claim 1, further comprising a memory configured to store instructions related to the IRC device.

13. An in-register computing (IRC) method comprising:
receiving, by a register module, data, the register module including register cells, the register cells including IRC cells, each IRC cell configured to perform an operation on data stored therein;
designating a first portion of the register cells as an input area in which an input value is stored;
designating a second portion of the register cells, including one or more of the IRC cells, as a weight area, wherein the one or more IRC cells of the weight area configured to perform their respective operations between the input value and a weight value in the one or more IRC cells; and
designating a third portion of the register cells as an output area configured to store a result of the operations on the input value.

14. The IRC method of claim 13, wherein the register cells are included in one or more register banks, and wherein the register module manages the registers cells according to their designated areas such that register cells in one of the designated areas are configured to perform one function based on their being in the one of the designated areas and such that register cells in another of the areas are configured to perform another function based on their being in another of the designated areas.

15. The IRC method of claim 13, wherein the register cells are comprised in register banks, wherein data lanes include the register banks, respectively, and wherein the register module is configured to:
compare a number of columns of a matrix of the weight value to the number of lanes; and
based on the comparing, control how many of the register cells are designated to the input area and how many of the register cells are designated to the output area.

16. The IRC method of claim 15, wherein the register module is further configured to:
control an operation order of the one or more IRC cells and control a method of storing the result of the operations based on a result of the comparing.

17. The IRC method of claim 13, wherein the register module is configured to:
control a method of storing a vector element in the input area and the output area based an operation method of the IRC method.

18. The IRC method of claim 13, wherein the register module is configured to:
control a number of vector elements to be stored in one of the register cells, based an operation method of the IRC method.

19. The IRC method of claim 13, further comprising:
designating the input area, the weight area, and the output area using different types of register files.

20. The IRC method of claim 13, wherein the register module comprises:
at least one of a scalar register, a vector register, or a floating register.
